(19) United States
(12) Patent Application Publication
(10) Pub. No.: US 2006/0285954 A1
(43) Pub. Date: Dec. 21, 2006

(54) Roof rack for vehicles

(76) Inventor: Timothy E. Neary, Essex Junction, VT (US)

Correspondence Address: SCHMEISER, OLSEN & WATTS, 22 CENTURY HILL DRIVE, SUITE 302, LATHAM, NY, 12110, US

(21) Appl. No.: 11/150,722

(22) Filed: Jun. 10, 2005

(51) Int. Cl. B62D 43/00

(52) U.S. Cl. 414/465

(57) ABSTRACT

A roof rack system for a vehicle. The roof rack system including: a roof rack system for a vehicle having a roof, comprising: a roof track having opposite first and second ends; a side track assembly, comprising: a shuttle track having opposite first and second ends; means for removeably attaching the side track assembly to the roof track and for positioning the first end of the shuttle track adjacent to the first end of the roof track; and a shuttle assist assembly mounted to the shuttle track, the shuttle assist assembly including means for exerting force on a shuttle when the shuttle is engaged the shuttle track; and a shuttle slideable in the roof track and in the shuttle track, moveable between the roof track and the shuttle track, and removable from the roof track and from the side track assembly.

### FIELD OF THE INVENTION

The present invention relates to a vehicular roof rack system; more specifically, it relates to a highly adaptable vehicular roof rack system with improved loading and unloading capability.

### BACKGROUND OF THE INVENTION

Roof racks are conventionally used for temporarily attaching loads such as skis, bicycles, small watercraft, luggage, building materials and other items to the roof of a vehicle for transport. For loading, the article must be lifted to the height of the roof of the vehicle. This can be difficult to accomplish for heavy or unwieldy articles with conventional roof racks currently available. Current designs address only specific load types and inadequately address heavy and unwieldy loads in general.

Therefore, there is a need for an improved vehicular roof rack system with load type adaptability and improved loading and unloading capability.

### SUMMARY OF THE INVENTION

The present invention is a system for moving a load from a low position (i.e. a side of a vehicle) to a higher position (a roof of a vehicle) and back again, using a roof track and demountable side tracks that engage the roof track, the side tracks including a lift assist mechanism engaging a shuttle that is free to move in tracks in the side track and the roof track.

A first aspect of the present invention is a roof rack system for a vehicle having a roof, comprising: a roof track having opposite first and second ends; a side track assembly, comprising: a shuttle track having opposite first and second ends; means for removeably attaching the side track assembly to the roof track and for positioning the first end of the shuttle track adjacent to the first end of the roof track; and a shuttle assist assembly mounted to the shuttle track, the shuttle assist assembly including means for exerting force on a shuttle when the shuttle is engaged in the shuttle track; and a shuttle slideable in the roof track and in the shuttle track, moveable between the roof track and the shuttle track, and removable from the roof track and from the side track assembly.

A second aspect of the present invention is a roof rack system for a vehicle having a roof, comprising: a hollow roof track having opposite upper and lower walls, opposite first and second sidewalls, opposite first and second ends and a slot in a the upper wall of the roof track extending through the upper wall of the roof track and extending from the first end to the second end of the roof track; the opposite upper and lower walls of the roof track, the opposite first and second sidewalls of the roof track and the slot in the upper wall of the roof track defining a roof track shuttle guide; a side track assembly, comprising: a hollow shuttle track having opposite upper and lower walls, opposite first, second sidewalls and opposite first and second ends and a slot in a the upper wall of the shuttle track extending through the upper wall of the shuttle track and extending from the first end to the second end of the shuttle track; the opposite upper and lower walls of shuttle track, the opposite first and second sidewalls of the shuttle track and the slot in a the upper wall of the shuttle track defining a side track shuttle guide; a pair of brackets fixed to the opposite sidewalls and adjacent to the first end of the track shuttle, the brackets engageable in pins fixed to the first and second sidewalls of and adjacent to the first and second ends of the roof track, the roof track shuttle guide and side track shuttle guide aligned when the pair of brackets are engaged in the pins; and a shuttle assist assembly mounted to the lower sidewall of the shuttle track, the shuttle assist assembly including a bracket, a bracket guide, a slot in the lower sidewall of the shuttle track, and means for exerting force on the bracket, the bracket having a lower portion captured in the bracket guide and an upper portion extending into the side track shuttle guide; and a shuttle engageable in the roof track shuttle guide and the side track shuttle guide, slideable in the roof track shuttle guide and in the side track shuttle guide, and removable from the roof track shuttle guide and the side track shuttle guide.

### BRIEF DESCRIPTION OF DRAWINGS

The features of the invention are set forth in the appended claims. The invention itself, however, will be best understood by reference to the following detailed description of an illustrative embodiment when read in conjunction with the accompanying drawings, wherein:

FIG. 1 is a side view of a roof rack system according to the present invention in its loading/unloading position;

FIG. 2A is a side view of a roof rack system according to the present invention in its loading/unloading position;

FIG. 2B is a side view of a roof rack system according to the present invention in its transporting position;

FIGS. 3A through 3D are a sequence of side views from the loading/unloading position to the transporting position of a roof rack system according to the present invention;

FIG. 4A is a top view and FIG. 4B is a side view of a first embodiment of a roof track of a roof rack system according to the present invention;

FIGS. 4C through 4F are cross-sectional views through lines 4C-4C, 4D-4D, 4E-4E and 4F-4F respectively of FIG. 4A;

FIG. 5A is a side view and FIG. 5B is a top view of a track engagement end of a removable side track assembly of a roof rack system according to the present invention;

FIG. 6A is a cross-sectional side view of a track engagement end of a removable side track assembly of a roof rack system according to the present invention;

FIG. 6B is a cross-sectional end view through line 6B-6B of FIG. 6A;

FIG. 6C is as cross-sectional view illustrating an alternative assist mechanism according to the present invention;

FIG. 7A is a side view, FIG. 7B is a top view and FIG. 7C is an end view of a shuttle assembly of a roof rack system according to a first embodiment of the present invention;

FIG. 8 is a cross-sectional side view of a lower end of a side track showing an alternative to a shuttle assembly of a roof rack system according to a second embodiment of the present invention;

FIG. 9A is a cross-sectional view and FIG. 9B is a top schematic view of a cam of a locking mechanism according to the present invention;

FIG. 10A is a cross-section through a locking mechanism locked in an un-engaged position according to the present invention;

FIG. 10B is a cross-section through a locking mechanism unlocked in an engaged position according to the present invention;

FIG. 10C is a cross-section through a locking mechanism in an engaged and locked position according to the present invention;

FIG. 11 is top view of a pair of carriers arranged to move in unison according to the present invention;

FIG. 12 is a top view of a multiple roof track roof rack of a roof rack system according to the present invention;

FIG. 13 is a side view of a roof track of a roof rack system according to a second embodiment the present invention;

FIG. 14 is a side view of a roof track of a roof rack system according to a third embodiment the present invention;

FIG. 15A is a side view and FIG. 15B is an end view of a shuttle assembly of a roof rack system according to a third embodiment of the present invention;

FIG. 16A is a side view and FIG. 16B is an end view of a shuttle assembly of a roof rack system according to a fourth embodiment of the present invention; and

FIG. 16C, is a partial cross section view of side track assembly of a roof rack for use with the fourth embodiment of the shuttle assembly.

### DETAILED DESCRIPTION OF THE INVENTION

A vehicle is defined as a conveyance for moving persons or cargo. Examples of vehicles according to the present invention include, automobiles, vans, trucks, buses and trailers. When an element of the present invention is indicated as mountable on a roof of a vehicle, it should also be understood that the element may be mounted on any relatively horizontal surface of the vehicle such as a hood, bed or body of the vehicle.

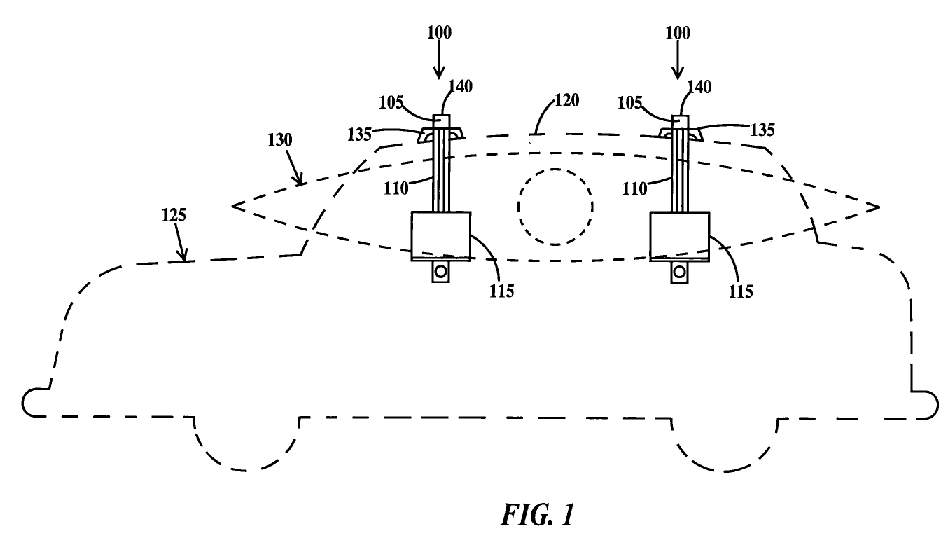

FIG. 1 is a side view of a roof rack system according to the present invention in its loading/unloading position. In FIG. 1 identical roof rack assemblies 100 each include a roof track 105, a side track assembly 110 and a carrier assembly 115. Rack assemblies 100 are illustrated mounted on a roof 120 of a vehicle 125 in the loading/unloading position with an exemplary load in the form of a kayak 130. Each roof rack assembly 100 includes two or more roof mounts 135 (only one roof mount for each roof rack assembly is illustrated in FIG. 1). Roof mounts 135 include an adjustment feature to move roof tracks 105 toward or away from roof 120 of vehicle 125 in order to bring top surfaces 140 of each roof track 105 into a common plane. Roof mounts 135 include means for securing roof tracks 105 to the top of vehicle 125. Many means for securing roof mounts to the tops of vehicles are known in the art. In one example, roof mounts 135 may comprise rubber cups that grip the roof and straps that secure to a vehicles roof gutter. In a second example, roof mounts 135 may be adapted to engage and locking mechanism into vehicle roof rails often supplied by the manufacturer of the vehicle.

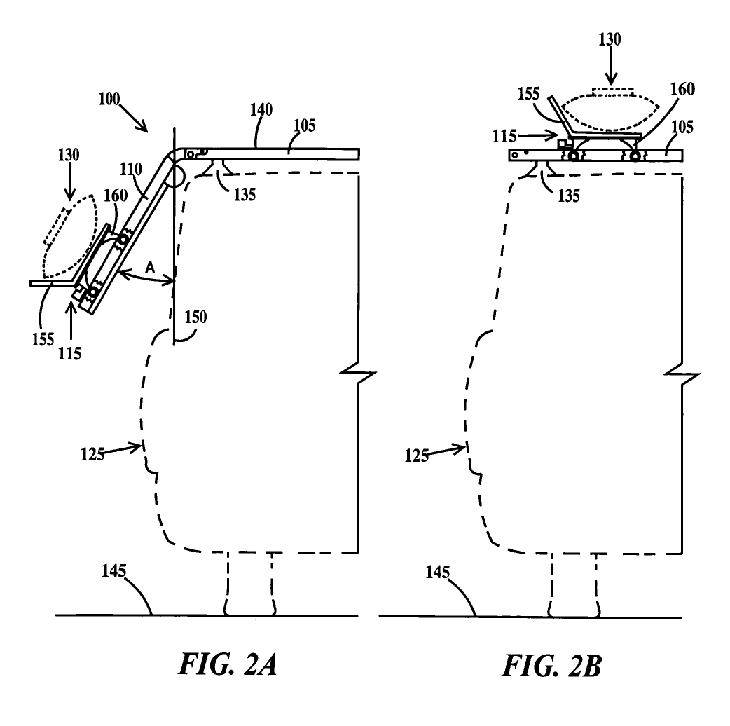

FIG. 2A is a side view of the roof rack system according to the present invention in its loading/unloading position. In FIG. 2A, a horizontal plane 145 is defined in a flat and level surface of the earth upon which vehicle 125 is disposed. A vertical plane 150 is defined as perpendicular to horizontal plane 145. When top surface 140 of roof track 105 is parallel to horizontal plane 145, side track assembly 110 is disposed at an angle A relative to vertical plane 150. In one example, angle A is between about 10° and about 50°. This makes the angle between roof track 105 and side track assembly between about 100° and about 140° which is an obtuse (greater than 90° but less than 180°) angle. Carrier assembly 115 comprises a cargo adapter 155 removeably mounted to a shuttle assembly 160. In FIG. 2A, side track 105 is cutaway in order to illustrate that shuttle assembly 160 is moveably and captively engaged in the side track as is described in more detail infra. In the particular example of FIG. 2A, cargo adapter 155 is designed for kayak 130. It is intended that any number of cargo adapters may be designed for specific cargos and may be interchangeably mounted on shuttle assembly 160.

FIG. 2B is a side view of a roof rack system according to the present invention in its transporting position. In FIG. 2B, roof track 105 is cutaway in order to illustrate that shuttle assembly 160 is moveably and captively engaged in the roof track as will be described in more detail infra. It should be noted, that in FIG. 2B, side track assembly 110 (see FIG. 2A) has been removed.

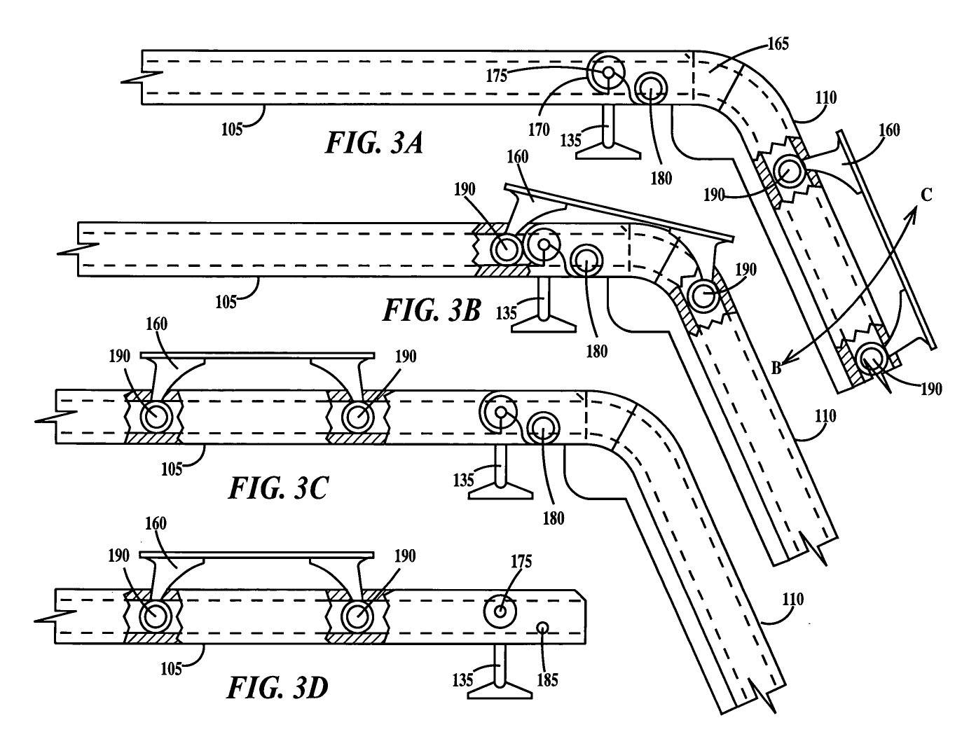

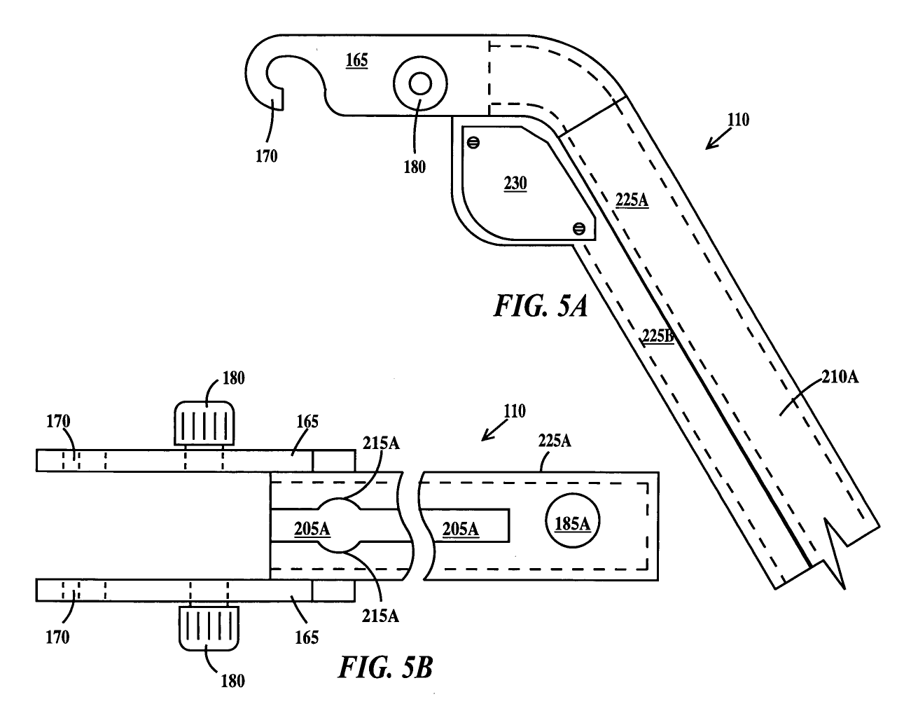

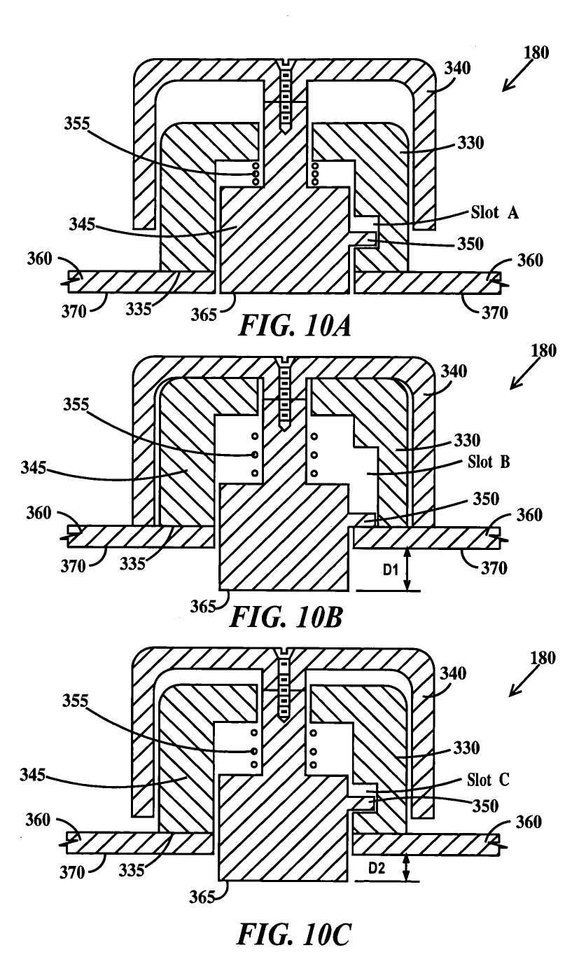

FIGS. 3A through 3D are a sequence of side views from the loading/unloading position to the transporting position of a roof rack system according to the present invention. In FIGS. 3A, 3B and 3C, a hooked flange 165 is attached to side track assembly 110 and a hook 170 formed in an end of the flange engages a flanged pin 175 mounted in a side of roof track 105. (The flange portion of flanged pin 175 is optional). Hooked flange 165 and flanged pin 170 are adapted to easily attach side track assembly 110 to roof track 105 by hooking the flanged pin with the hook and swinging the roof track in the B direction. Swinging side track in the C direction allows side track assembly 110 to be removed from roof track 105. This quick attach mechanism is illustrated in FIGS. 5A and 5B and described in more detail infra. An optional locking mechanism 180 is mounted on hooked flange 165 and is adapted to engage or disengage a pin capture hole 185 (see FIG. 3D) in an end of roof track 105. Locking mechanism 180 is illustrated in FIGS. 9A, 9B, 10A, 10B and 10C and described in more detail infra. Locking mechanism 180 is used to temporarily lock various parts of the roof rack system together as described infra.

In FIGS. 3A, 3B, 3C and 3D, roof track 105 or side track assembly 110 or both are shown cutaway in order to illustrate wheels 190 on shuttle assembly 160 captured in shuttle guides (represented by the dashed lines) formed internal to the roof track and the side track assembly. In FIG. 3A, shuttle assembly 160 is completely within side track assembly 110. In FIG. 3B, shuttle assembly 160 is transitioning from side track assembly 110 to roof track 105. In FIG. 3C, shuttle assembly 160 is completely within roof track 105. In FIG. 3D, side track assembly 110 (see FIG. 3C) has been removed.

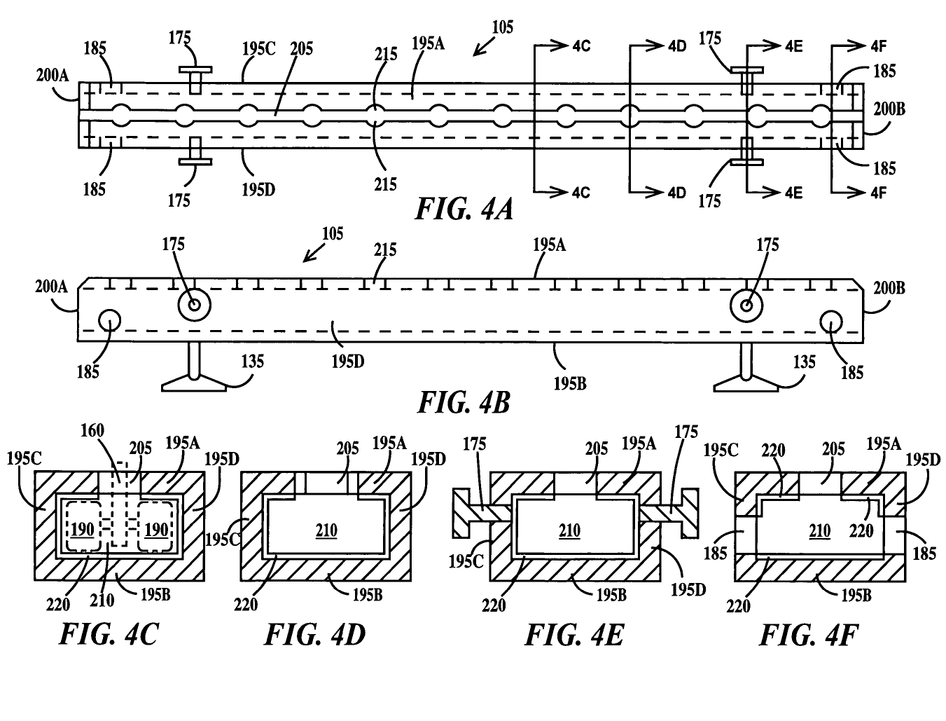

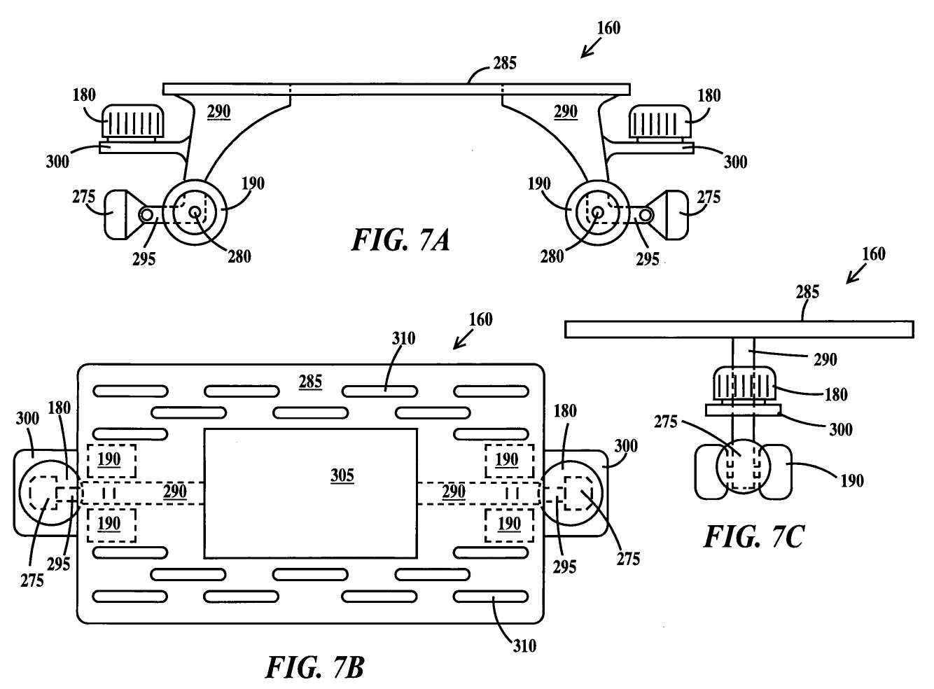

FIG. 4A is a top view and FIG. 4B is a side view of a first embodiment of roof track 105 of a roof rack system according to the present invention. In FIGS. 4A and 4B, roof track 105 is seen to be of the form of a hollow rectangular tube having a top wall 195A, a bottom wall 195B and opposite first and second sidewalls 195C and 195D and open at opposite ends 200A to second end 200B completely through top wall 195A. A shuttle guide 210 is defined by top wall 195A, bottom wall 195B, first sidewall 195C and second sidewalls 195D. Slot 205 centered over shuttle guide 210 and is not as wide as shuttle guide 210. Slot 205 is open to shuttle assembly track 210 and together slot 205 and shuttle guide 210 define a “T” slot. Periodically formed in sidewalls of slot 205 are semicircular notches 215. Semi-circular notches 215 are adapted to engage a pin of an optional locking mechanism 180 attached to a shuttle assembly as illustrated in FIGS. 7A, 7B and 7C and described infra. A first pair of flanged pins 175 are mounted to and a first pair of pin capture holes 185 are formed in first and second sidewalls 195C and 195D adjacent to first end 200A and a second pair of flanged pins 175 are mounted to and a second pair of pin capture holes 185 are formed in first and second sidewalls 195C and 195D adjacent to second end 200B.

FIGS. 4C through 4F are cross-sectional views through lines 4C-4C, 4D-4D, 4E-4E and 4F-4F respectively of FIG. 4A. In FIGS. 4C, 4D, 4E and 4F an optional low resistance coating 220 is formed on all interior surfaces of shuttle guide 210. In one example, low-friction coating 220 is a fluorocarbon polymer. In FIG. 4C, dashed lines illustrate how wheels 190 of shuttle assembly 160 (only a portion shown) are captured by shuttle guide 210 of roof track 105.

Generally, roof tracks 105 are used in pairs, but it is possible to use just one or three or more on the same vehicle. Roof track 105 may be fabricated, for example, from aluminum, steel, plastic, glass filled resin, fiberglass or any other suitable material or combinations thereof.

FIG. 5A is a side view and FIG. 5B is a top view of a track engagement end of removable side track assembly 110 of a roof rack system according to the present invention. In FIGS. 5A and 5B, side track assembly 110 includes two flanges 165 (each flange having a hook 170, see FIG. 5B), a shuttle track 225A and a shuttle assist assembly 225B mounted under shuttle track 225A. Within shuttle track 225A which includes a slot 205A, is a shuttle guide 210A. Shuttle guide 210A is similar to shuttle guide 210 (see FIGS. 4A and 4B 4C). Shuttle track 225A includes a pin capture hole 185A adapted to engage a pin of optional locking mechanisms on shuttle assembly 160 (see FIGS. 7A, 7B and 7C) when the shuttle assembly is in a lowermost or loading position. Shuttle track 225A may include semi-circular notches 215A formed in the sidewalls of slot 205A to be engaged by another locking mechanism 180 mounted on shuttle assembly 160 (see FIGS. 7A, 7B and 7C)to hold the shuttle assembly in locations on side track assembly 110 other than the loading position. Shuttle assist assembly 225B includes an access lid 230 in order to gain access to the assist mechanism for adjustment or replacement. While two locking mechanisms 180 are illustrated in FIG. 5B, one on either of flanges 165, one or none may be employed.

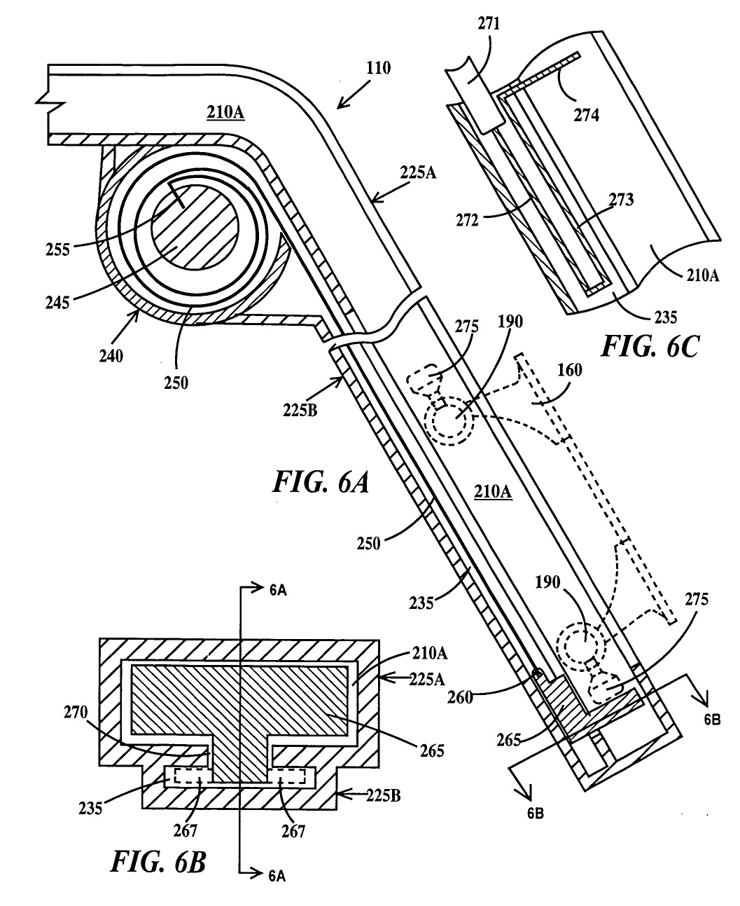

FIG. 6A is a cross-sectional side view of a track engagement end of removable side track assembly 110 of a roof rack system according to the present invention and FIG. 6B is a cross-sectional end view through line 6B-6B of FIG. 6A. FIG. 6A is taken through line 6A-6A of FIG. 6B. In FIGS. 6A and 6B, wheels 190 of shuttle assembly 160 are illustrated engaged in shuttle guide 210A. Slot 205A is open to shuttle guide 210A and together slot 205A and shuttle guide 210A define an upper “T” slot. Shuttle assist assembly 225B includes a clock spring guide 235 under shuttle guide 210A and a spring chamber 240 under shuttle guide 210A adjacent to flange 165 (see FIG. 5A). Spring chamber 240 houses a drum 245 on which a clock spring 250 is wound, a first end 255 of the clock spring is engaged in drum 245. Clock spring 250 is fed through clock spring guide 235 and a second end 260 of the clock spring is connected to a bracket 265 engaged in shuttle guide 210A and extending into spring guide 235 through a slot 270 connecting shuttle guide 210A and spring guide 235.

Clock spring 250 is a retracted coil fitted over drum 245 in its relaxed position. Clock spring 250 comes under tension as it is pulled away from drum 245. Bracket 265 is automatically pulled up toward drum 245 as spring 250 recoils on the drum and the tension on the spring decreases. Drum 245 is locked in position and does not rotate as clock spring 250 coils and uncoils as bracket 265 is moved. As bracket 265 is pulled down by the user pulling on shuttle assembly 160, the bracket is pulled away from the drum and the tension on spring 250 increases. Optional bumpers 275 are provided on shuttle assembly 160 to prevent wheels 190 from contacting bracket 265. Thus, power assist in moving heavy loads from the load position (see FIG. 2A) to the transport position (see FIG. 2B) is provided. In one example, clock spring 250 provides about 5 to about 50 foot-pounds of assist force. Bracket 265 may include an optional flange 267 to engage clock spring guide 235.

Optionally, when bracket 265 is pulled as close as possible to drum 245, clock spring 250 may be removed from drum 245 and replaced in the field by the user with a different spring having a different assist force. In an alternative embodiment, clock spring 250 may be replaced with a coil spring, an elastomer strap or elastomer cord. In an alternative embodiment drum 245 may be adapted to be adjustable in order to increase or decrease the tension on clock spring 250 (or the elastomer strap or cord). In an alternative embodiment clock spring 250 and drum 245 may be replaced by a reversible direction motor and appropriate gearing.

FIG. 6C is as cross-sectional view illustrating an alternative assist mechanism according to the present invention. In FIG. 6C, a hydraulic cylinder 271 with a piston 272, such as a gas strut and a recursive bracket 273 is attached to cylinder 272 and the assembly fitted into guide 235. An end 274 of recursive bracket 273 projects into shuttle guide 210A.

Side track assembly 110 may be fabricated, for example, from aluminum, steel, plastic, glass filled resin, fiberglass, any other suitable material or combinations thereof.

FIG. 7A is a side view, FIG. 7B is a top view and. FIG. 7C is an end view of shuttle assembly 160 of a roof rack system according to a first embodiment of the present invention. In FIGS. 7A and 7B, shuttle assembly 160 includes wheels 190 mounted on axles 280, a mounting plate 285, struts 290 connecting mounting plate 285 to axles 280, optional bumpers 275 connected to struts 275 by brackets 295 and optional locking mechanisms 180 are connected to struts 290 by brackets 300. Turning to FIG. 7B, mounting plate 285 includes a centrally located optional clearance opening 305 and a multiplicity of attachment slots 310 which extend through the thickness of mounting plate 285. The purpose of clearance opening 305 is to allow quick turning (in terms of turning through an angle) as shuttle assembly 160 transitions from side track assembly 110 to roof track 105 (see FIG. 3B). The purpose of attachment slots 305 is to allow temporary mounting of any number of different cargo adapters to shuttle assembly 160. See, for example, a cargo adapter 155 in FIG. 2A.

Shuttle assembly 160 may be fabricated, for example, from aluminum, steel, plastic, glass filled resin, fiberglass, any other suitable material or combinations thereof. Wheels 190 may be fabricated, for example, from aluminum, steel, plastic, rubber, polyurethane or fluoro-carbon polymers. Bumpers 275 may be fabricated, for example, rubber, polyurethane or fluorocarbon polymers.

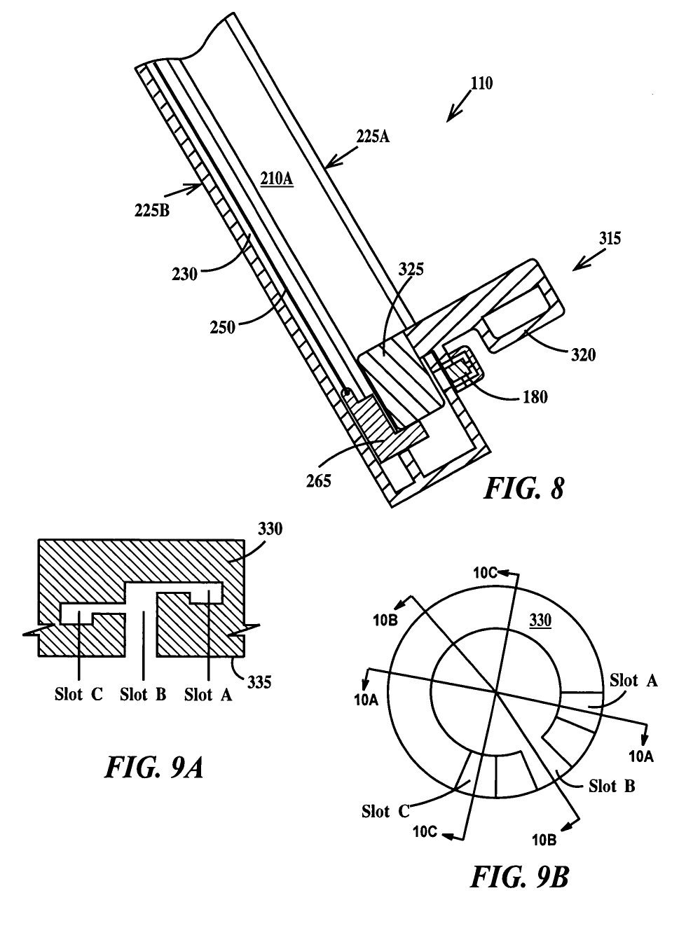

FIG. 8 is a cross-sectional side view of a lower end of a side track assembly 110 showing an alternative to a shuttle assembly according to a second embodiment of the roof rack system of the present invention. In FIG. 8, a load slider 315 includes a handle 320 connected to a bearing 325 (or integrally formed with) which is engaged in shuttle guide 210A and optional locking mechanism 180. Load slider 315 is moved along shuttle guide 210A the same as shuttle assembly 160 illustrated in FIG. 6A and described supra. If bearing 325 is small enough, load slider may be slid into roof rack 105 similarly to shuttle 160 (see FIGS. 3A, 3B, 3C and 3D).

FIG. 9A is a cross-sectional view and FIG. 9B is a top schematic view of a cam 330 of locking mechanism 180 of FIGS. 5B, 7A and 8. Slot A is located a furthest distance from a bottom 335 of cam 330. Slot B is open to bottom 335 of cam 330. Slot C is located a distance part way between Slot A and bottom 335 of cam 330. Slot A is a locked pin up position or locked and not engaged position of locking mechanism 180. Slot B is an automatic pin engage position or auto-engage position of the locking mechanism 180. Slot C is a locked pin down position or locked and engaged position of the locking mechanism 180.

FIG. 10A is a cross-section through locking mechanism 180 locked in an un-engaged position according to the present invention. In FIG. 10A, locking mechanism 180 includes a knob 340, cam 330, a pin 345 and a cam follower 350 attached to or integral with pin 345. A spring 355 is positioned between cam 330 and pin 345 so as to always exert outward force on the pin. Knob 340 is fixed to pin 345 so the pin rotates when the knob is rotated and moves in and out and the knob moves in and out as cam follower 350 follows Slot A, Slot B and Slot C. Cam 330 is fixedly mounted to a mounting surface plate 360. Mounting plate 360 comprises either flange 165 (see FIG. 5A) or bracket 300 (see FIG. 7B).

In FIG. 10A, locking mechanism 180 is in its locked and not engaged position and a bottom surface 365 is flush with (or recessed below) a bottom surface 370 of mounting plate 360. In this position, pin 345 cannot move away from cam 330.

FIG. 10B is a cross-section through locking mechanism 180 unlocked in an engaged position according to the present invention. In FIG. 10B, locking mechanism 180 is in its auto-engage position and a bottom surface 365 extends a distance D1 past bottom surface 370 of mounting plate 360. In this position, pin 345 automatically moves away from cam 330 when positioned over an opening, for example opening 185 and notches 215 of top rack. 105 of FIGS. 4A and 4B or opening 185A and notches 215A of a side track assembly 110 of FIG. 5B.

FIG. 10C is a cross-section through locking mechanism 180 in an engaged and locked position according to the present invention. In FIG. 10C, locking mechanism 180 is in its locked and engaged position and a bottom surface 365 is extends a distance D2 past bottom surface 370 of mounting plate 360. In this position, pin 345 cannot move toward cam 330. D2 is less than D1.

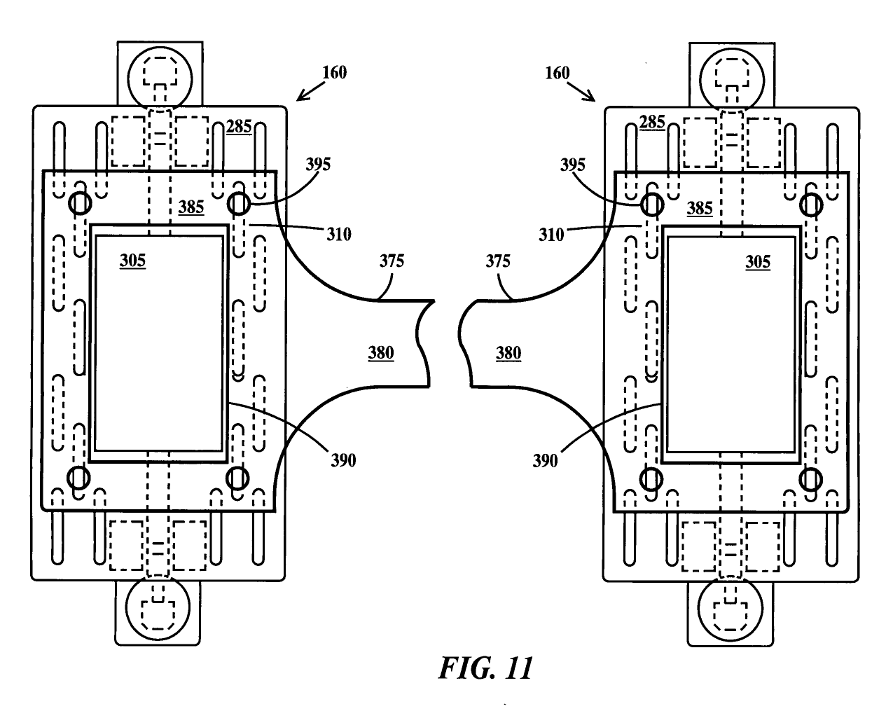

FIG. 11 is top view of a pair of shuttle assemblies 160 arranged to move in unison of a roof rack system according to the present invention. In FIG. 11, a connector 375 includes two attachment plates 385 connected to each other by a strut 380. Attachment plates 385 include openings 390 that align with opening 305 in mounting plate 285 of shuttle assembly 160 and mounting holes 395 that align with attachment slots 310 in mounting plate 285. Two roof tracks and two side track assemblies are required in this configuration.

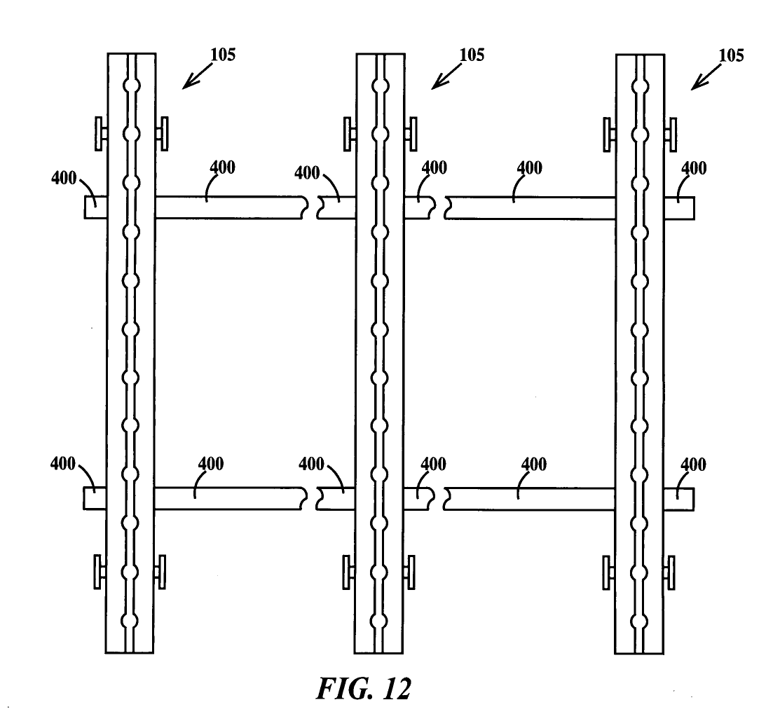

FIG. 12 is a top view of a multiple roof track roof rack system according to the present invention. In FIG. 12, three or more roof tracks 105 are mounted to cross-bars 400. Cross-bars 400 may be mounted to the roof by any number of methods known in the art. In one example, cross-bars 400 are fabricated from box beam or “U” channel.

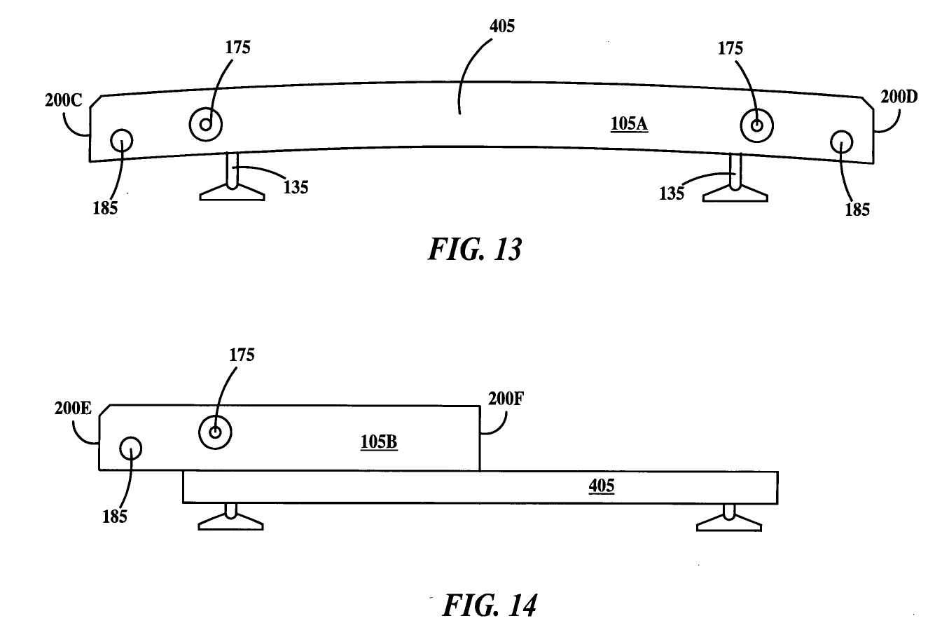

FIG. 13 is a side view of a roof track 105A of a roof rack system according to a second embodiment the present invention. In FIG. 13, roof track 105A is similar to roof track 105 of FIG. 4B except that the roof track is curved away from the vehicle top. A central portion 405 of roof track 105A is curved away from distal ends 200C and 200D.

It should be noted that side track assemblies 110 (see FIG. 5A) may be attached to either end 200A or 200B of roof track 105 of FIG. 4B or either end 200C or 200D of roof track 105A depending from which side of the vehicle loading is to be performed and from which side of the vehicle unloading is to be performed from. Loading and unloading can be performed from either side of the vehicle and loading does not need to be performed from the same side of the vehicle as unloading because the side track assemblies are removable and universally attachable.

FIG. 14 is a side view of a roof track 105B of a roof rack system according to a third embodiment the present invention. In FIG. 14, roof track 105B is similar to roof track 105 of FIG. 4B except that roof track 105B has only one end (a first end 205E) to which a side track assembly 110 (see FIG. 5A) may be mounted. A second end 200F may be closed so as to prevent a shuttle from being removed or being pushed out of roof track 105B. Also roof track 105B may mounted to any conventional roof rack 405.

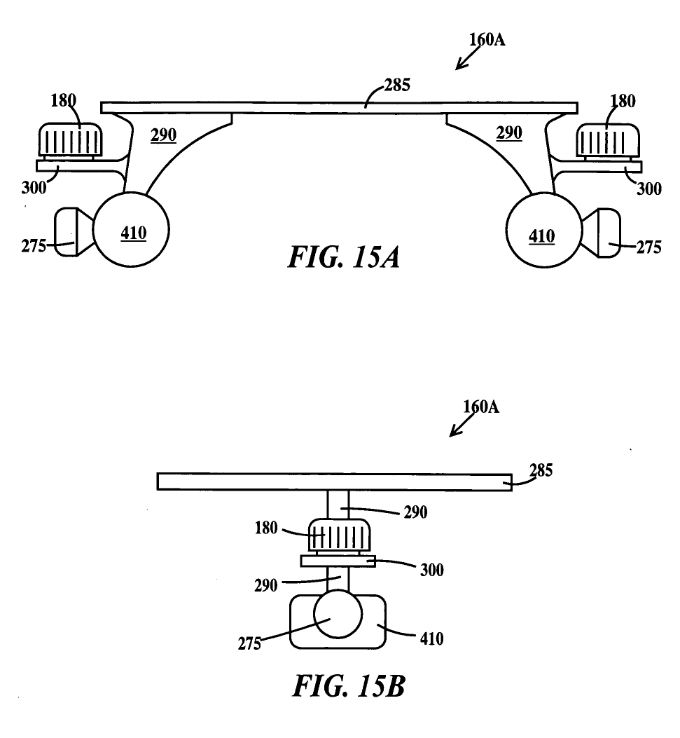

FIG. 15A is a side view and FIG. 15B is an end view of a shuttle assembly 160A of a roof rack system according to a third embodiment of the present invention. In FIGS. 15A and 15B, shuttle assembly 160A is similar to shuttle assembly 160 of FIGS. 7A, 7B and 7C except that wheels 190 and axels 280 (see FIG. 7A) are replaced with non-rotatable pins 410 connected to strut 290 and bumpers 275 are connected directly to pins 410.

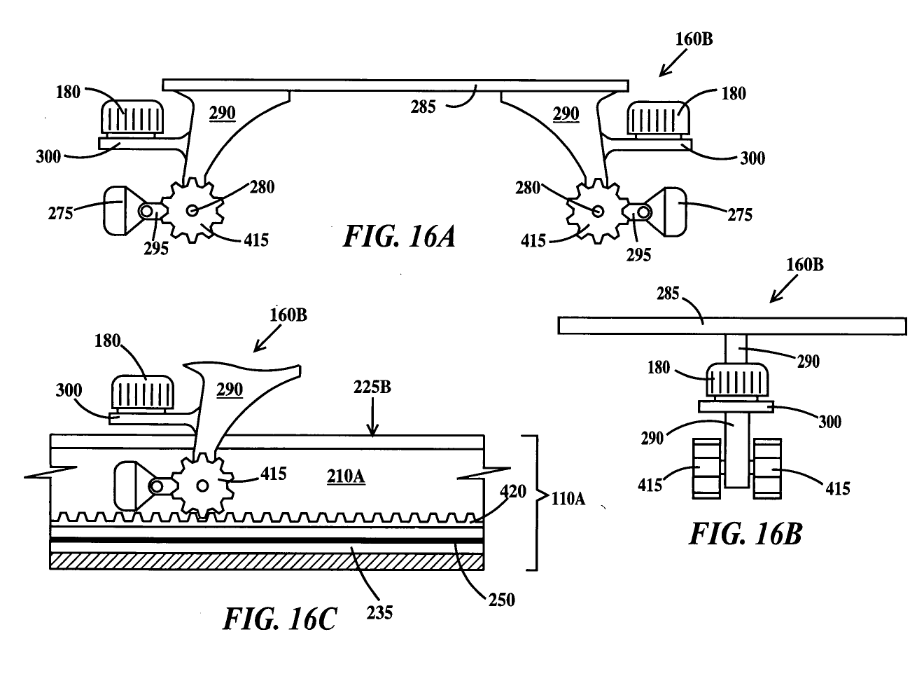

FIG. 16A is a side view and FIG. 16B is an end view of a shuttle assembly 160B of a roof rack system according to a fourth embodiment of the present invention. In FIGS. 16A and 16B, shuttle assembly 160B is similar to shuttle assembly 160 of FIGS. 7A, 7B and 7C except that wheels 190 (see FIG. 7A) are replaced with toothed wheels (or pinions) 415.

FIG. 16C, is a partial cross section view of side track assembly 110A of a roof rack of a roof rack system for use with the fourth embodiment of the shuttle assembly. In FIG. 16C, side track assembly 110A is similar to side track assembly 110 of FIG. 6A except shuttle track 225B includes toothed track (or rack) 420. Teeth on toothed wheel (pinion) 415 are adapted to mesh with teeth toothed track 420. Similarly, toothed tracks (racks) may be mounted on bottom wall 195B top track 105 (see FIG. 4B). Spring 250 is shown in clock spring guide 235.

Thus, the present invention provides an improved vehicular roof rack system with load type adaptability and improved loading and unloading capability.

Additionally, the present invention is capable of being mounted to any relatively horizontal surface for example, a table or bench top, a deck or the roof of a shed in order to assist moving loads from the side of the table or bench top, deck or shed to the table or bench top, deck surface or shed roof, respectively, and back again.

The description of the embodiments of the present invention is given above for the understanding of the present invention. It will be understood that the invention is not limited to the particular embodiments described herein, but is capable of various modifications, rearrangements and substitutions as will now become apparent to those skilled in the art without departing from the scope of the invention. Therefore, it is intended that the following claims cover all such modifications and changes as fall within the true spirit and scope of the invention.

What is claimed is:

1. A roof rack system for a vehicle having a roof, comprising:
a roof track having opposite first and second ends;
a side track assembly, comprising:
a shuttle track having opposite first and second ends;
means for removeably attaching said side track assembly to said roof track and for positioning said first end of said shuttle track adjacent to said first end of said roof track; and
a shuttle assist assembly mounted to said shuttle track, said shuttle assist assembly including means for exerting force on a shuttle when said shuttle is engaged in said shuttle track; and
a shuttle slideable in said roof track and in said shuttle track, moveable between said roof track and said shuttle track, and removable from said roof track and from said side track assembly.

2. The roof rack system of claim 1, wherein said shuttle is removable from said roof track only at said first end of said roof track and is removable from said shuttle track only from said first end of said shuttle track.

3. The roof rack system of claim 1, further including:
means for temporarily locking said shuttle in one or more positions on said shuttle track; and
means for temporarily locking said shuttle in one or more positions on said roof track.

4. The roof rack system of claim 1, further including means for temporarily locking said side track assembly to said first end of said roof track.

5. The roof rack system of claim 1, wherein said means for exerting force comprises a clock spring, a coil spring, an elastomer strap or an elastomer cord.

6. The roof rack system of claim 1, wherein said means for exerting force comprises field replaceable components having different assist force ratings.

7. The roof rack system of claim 1, further including:
one or more additional roof tracks, each additional roof track essentially identical to said roof track, each said one or more additional roof tracks disposed parallel to said roof track;
one or more additional side track assemblies, each additional side track assembly essentially identical to said side track assembly; and
one or more additional shuttles, each additional shuttle essentially identical to said shuttle.

8. The roof rack system of claim 1, when said side track assembly is attached to said first end of said roof track, said side track assembly extending away from said roof track at an obtuse angle to said roof track.

9. The roof rack system of claim 1, further including
means for removeably attaching said side track assembly to said second end of said roof track.

10. The roof rack system of claim 9, wherein said shuttle is removable from said roof track at said second end of said roof track.

11. The roof rack system of claim 9, further including means for temporarily locking said side track assembly to said second end of said roof track.

12. The roof rack system of claim 11, when said side track assembly is attached to said second end of said roof track, said side track assembly extending away from said roof track at an obtuse angle to said roof track.

13. A roof rack system for a vehicle having a roof, comprising:
a hollow roof track having opposite upper and lower walls, opposite first and second sidewalls, opposite first and second ends and a slot in a said upper wall of said roof track extending through said upper wall of said roof track and extending from said first end to said second end of said roof track;
said opposite upper and lower walls of said roof track, said opposite first and second sidewalls of said roof track and said slot in said upper wall of said roof track defining a roof track shuttle guide;
a side track assembly, comprising:
a hollow shuttle track having opposite upper and lower walls, opposite first, second sidewalls and opposite first and second ends and a slot in a said upper wall of said shuttle track extending through said upper wall of said shuttle track and extending from said first end to said second end of said shuttle track;
said opposite upper and lower walls of shuttle track, said opposite first and second sidewalls of said shuttle track and said slot in a said upper wall of said shuttle track defining a side track shuttle guide;
a pair of brackets fixed to said opposite sidewalls and adjacent to said first end of said track shuttle, said brackets engageable in pins fixed to said first and second sidewalls of and adjacent to said first and second ends of said roof track, said roof track shuttle guide and side track shuttle guide aligned when said pair of brackets are engaged in said pins; and
a shuttle assist assembly mounted to said lower sidewall of said shuttle track, said shuttle assist assembly including a bracket, a bracket guide, a slot in said lower sidewall of said shuttle track, and means for exerting force on said bracket, said bracket having a lower portion captured in said bracket guide and an upper portion extending into said side track shuttle guide; and
a shuttle engageable in said roof track shuttle guide and said side track shuttle guide, slideable in said roof track shuttle guide and in said side track shuttle guide, and removable from said roof track shuttle guide and said side track shuttle guide.

14. The roof rack system of claim 13, further including:
a first set of notches formed along said slot in a said upper wall of said roof track;
a second set of notches formed along said slot in a said upper wall of said shuttle track; and
one or more locking mechanisms attached to said shuttle and reversibly engageable in said first or said second set of notches.

15. The roof rack system of claim 13, further including
guide holes formed in opposite sidewalls of and adjacent to said first end of said shuttle track;
at least one locking mechanism attached to one of said flanges and reversibly engageable in said guide holes.

16. The roof track system of claim 13, further including a spring, a coil spring, an elastomer strap or an elastomer cord disposed in said bracket guide and attached to said bracket, said spring, said coil spring, said elastomer strap or said elastomer cord exerting a maximum force on said bracket when said bracket is disposed adjacent to said second end of said shuttle track.

17. The roof track system of claim 13, further including:
one or more additional roof tracks, each additional roof track essentially identical to said roof track, each said one or more additional roof tracks disposed parallel to said roof track;
one or more additional side track assemblies, each additional side track assembly essentially identical to said side track assembly; and
one or more additional shuttles, each additional shuttle essentially identical to said shuttle.

18. The roof track system of claim 13, when said first end of said shuttle track is attached to either said first or said end of said roof track, said second end of said shuttle track extending away from and below said roof track at an angle of between about 100° and about 140°.

19. The roof track system of claim 13, wherein said roof track is curved such that said first and second ends of said roof track curve away from a central region of said roof track, said upper wall of said roof track on the outside of said curve and said lower wall on the inside of said curve.

20. The roof track system of claim 13, further including a low friction coating formed on inner surfaces of said roof track shuttle guide, inner surfaces of said side track shuttle guide, or both inner surfaces of said roof track shuttle guide and said side track shuttle guide.

21. The roof rack system of claim 13, wherein:
said shuttle comprises a first pair of wheels rotateably mounted to a first strut and a second pair of wheels rotateably mounted to a second strut, said struts spaced apart a attached perpendicularly to a mounting plate, said wheels engageable in both said roof track shuttle guide and said side track shuttle guide, said mounting plate disposed outside of said roof track shuttle guide and said side track shuttle guide.

22. The roof track system of claim 13, wherein:
said shuttle comprises a first pin fixedly mounted to a first strut and a second pin fixedly mounted to a second strut, said struts spaced apart a attached perpendicularly to a mounting plate, said pins engageable in both said roof track shuttle guide and said side track shuttle guide, said mounting plate disposed outside of said roof track shuttle guide and said side track shuttle guide.

23. The roof rack system of claim 13, wherein:
said shuttle comprises a first pair of pinions rotateably mounted to a first strut and a second pair of pinions rotateably mounted to a second strut, said struts spaced apart a attached perpendicularly to a mounting plate, said wheels engageable in racks within both said roof track shuttle guide and said side track shuttle guide, said mounting plate disposed outside of said roof track shuttle guide and said side track shuttle guide.

24. The roof rack system of claim 13, wherein:
said shuttle comprises a bearing and a handle, said bearing engageable in both said roof track shuttle guide and said side track shuttle guide, said handle disposed outside of said roof track shuttle guide and said side track shuttle guide.
